(19) United States
(12) Patent Application Publication
(10) Pub. No.: US 2026/0032310 A1
(43) Pub. Date: Jan. 29, 2026

(54) DISPLAY DEVICE AND OPERATION METHOD THEREOF

(71) Applicant: LG ELECTRONICS INC., Seoul (KR)

(72) Inventor: Seungnam BAE, Seoul (KR)

(73) Assignee: LG ELECTRONICS INC., Seoul (KR)

(21) Appl. No.: 18/997,287

(22) PCT Filed: Jul. 20, 2022
(86) PCT No.: PCT/KR2022/010642

§ 371 Date: Jan. 21, 2025

(30) Foreign Application Priority Data
Jul. 20, 2022 (KR) 10-2022-0089464

(51) Int. Cl. H04N 21/443; H04N 21/422; H04N 21/442

(52) U.S. Cl. CPC H04N 21/4436; H04N 21/42202; H04N 21/4424

(57) ABSTRACT

A display device and an operation method thereof are disclosed. The display device according to an embodiment of the present invention comprises: a memory; a processing unit which includes a temperature sensor; and a power supply unit which supplies power to the processing unit, wherein, depending on a temperature value by the temperature sensor, the processing unit transmits a GPIO control command to the power supply unit to control such that a core voltage value corresponding to the GPIO control command is applied through the power supply unit.

### TECHNICAL FIELD

The present disclosure relates to a display device, and more specifically, to a display device that operates by controlling power by directly considering temperature rather than semiconductor characteristics of a processor, and its operation method.

### BACKGROUND ART

A display device is a device having a function of receiving, processing, and displaying an image that a user can view. For example, the display device receives a broadcast signal selected by a user among broadcast signals transmitted from a broadcasting station, separates an image signal from the received signal, and then displays the separated image signal on a display.

Meanwhile, conventional display devices control core power using only a value of a leakage current (SIDD) of a System on a chip (SoC). At this time, the value of the leakage current (SIDD) is provided by, for example, the SoC manufacturer.

However, in conventional display devices, even when the value of the leakage current (SIDD) provided by the SoC manufacturer is the same, the load is different due to the characteristics of a semiconductor element and a tolerance of the SoC, and a power consumption accordingly is also different.

For the above reasons, in conventional display devices, thermal shutdown or DC/DC OCP failure due to a leakage, image breakage, etc. are connected due to the above reasons, and defect symptoms such as image breakage under heavy load conditions, power shutdown, power infinite auto rebooting, and board long-term reliability issues occur.

Therefore, a heat dissipation measure for the display device that takes such deviations into account is required.

### DETAILED DESCRIPTION OF THE INVENTION

### Technical Problem

The purpose of the present disclosure is to provide a display device and an operation method thereof that automatically control a core voltage by monitoring a temperature since a Tⱼ temperature of a SoC is dependent on the SoC load/power consumption.

### Technical Solution

A display device according to an embodiment of the present invention can include a memory; a processor including a temperature sensor; and a power supply unit for supplying power to the processor, wherein the processor is configured to transmit a GPIO control command to the power supply unit according to a temperature value sensed by the temperature sensor, and control a core voltage value corresponding to the GPIO control command to be applied through the power supply unit.

A method of operating a display device according to an embodiment of the present invention can include generating and storing a lookup table in which a temperature of a System on Chip (SoC), a core voltage value to be applied to the SoC, and a GPIO control command for applying the core voltage value are mapped; reading a temperature of the SoC through a temperature sensor installed in a SoC die; calculating a core voltage value corresponding to the read current temperature of the SoC; generating a GPIO control command corresponding to the calculated core voltage value and transmitting it to a power IC; and controlling a supply power according to the transmitted GPIO control command.

### Effect of the Invention

The display device according to one embodiment of the present disclosure has an effect of automatically controlling a core voltage through SOC Tⱼ temperature monitoring.

The display device according to one embodiment of the present disclosure can be designed to maintain a temperature and power consumption of a SoC constant or adaptively respond to changes therein, so that it has an effect of minimizing a defect rate.

The display device according to one embodiment of the present invention can design an optimal solution as a heat dissipation measure according to the characteristics of a semiconductor, a resistance of a SoC, etc., so that it has an effect of reducing cost waste.

### BRIEF DESCRIPTION OF THE DRAWINGS

FIG. 1 is a block diagram illustrating a configuration of a display device according to an embodiment of the present disclosure.

FIG. 2 is a block diagram of a remote control device according to an embodiment of the present disclosure.

FIG. 3 illustrates an example of an actual configuration of a remote control device according to an embodiment of the present disclosure.

FIG. 4 illustrates an example of utilizing a remote control device according to an embodiment of the present disclosure.

FIG. 5 is a diagram illustrating a core voltage automatic control device according to an embodiment of the present disclosure.

FIG. 6 is a block diagram illustrating a configuration of a core voltage automatic control device of FIG. 5.

FIG. 7 is a block diagram illustrating a configuration of a power control circuit module of FIG. 6.

FIGS. 8 and 9 are flowcharts illustrating a power control method in a display device according to an embodiment of the present disclosure.

FIG. 10 is a graph illustrating a power control method of FIG. 8.

FIG. 11 illustrates a lookup table according to one embodiment of the present invention.

FIGS. 12 to 14 are flowcharts illustrating a power control method in a display device according to another embodiment of the present invention.

### BEST MODE

Hereinafter, embodiments related to the present invention will be described in more detail with reference to the drawings. The suffixes “module” and “part” used for components in the following description are given or used interchangeably only for the convenience of writing the specification, and do not have distinct meanings or roles in themselves.

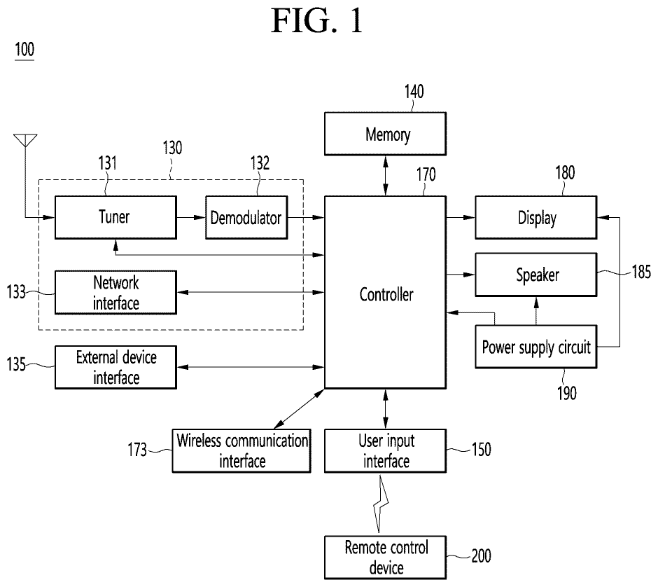

FIG. 1 is a block diagram illustrating the configuration of a display device according to an embodiment of the present invention.

Referring to FIG. 1, the display device 100 can include a broadcast receiving unit 130, an external device interface unit 135, a memory 140, a user input interface 150, a controller 170, a wireless communication interface 173, a voice acquisition unit 175, a display 180, an audio output unit 185, and a power supply unit 190.

The broadcast receiving unit 130 can include a tuner 131, a demodulator 132, and a network interface unit 133.

The tuner 131 can select a specific broadcast channel according to a channel selection command. The tuner 131 can receive a broadcast signal for the selected specific broadcast channel.

The demodulator 132 can separate the received broadcast signal into a video signal, an audio signal, and a data signal related to a broadcast program, and can restore the separated video signal, audio signal, and data signal into a form that can be output.

The network interface unit 133 can provide an interface for connecting the display device 100 to a wired/wireless network including the Internet. The network interface unit 133 can transmit or receive data with another user or another electronic device through the connected network or another network linked to the connected network.

The network interface unit 133 can access a predetermined web page through the connected network or another network linked to the connected network. In other words, it can access a predetermined web page through the network and transmit or receive data with the corresponding server.

In addition, the network interface unit 133 can receive content or data provided by a content provider or a network operator. In other words, the network interface unit 133 can receive content such as movies, advertisements, games, VOD, broadcast signals, etc. and information related thereto provided from a content provider or a network provider through the network.

In addition, the network interface unit 133 can receive firmware update information and update files provided by the network operator, and can transmit data to the Internet or the content provider or the network operator.

The network interface unit 133 can select and receive a desired application from among applications open to the public through the network.

The external device interface unit 135 can receive an application or an application list in an adjacent external device and transmit it to the controller 170 or the storage unit 140.

The external device interface unit 135 can provide a connection path between the display device 100 and the external device. The external device interface unit 135 can receive one or more of images and audio output from an external device connected wirelessly or wiredly to the display device 100 and transmit it to the controller 170. The external device interface unit 135 can include a plurality of external input terminals. The plurality of external input terminals can include an RGB terminal, one or more High-Definition Multimedia Interface (HDMI) terminals, and a component terminal.

The image signal of the external device input through the external device interface unit 135 can be output through the display 180. The voice signal of the external device input through the external device interface unit 135 can be output through the audio output unit 185.

The external device that can be connected to the external device interface unit 135 can be any one of a set-top box, a Blu-ray player, a DVD player, a game console, a sound bar, a smartphone, a PC, a USB memory, and a home theater, but this is only an example.

In addition, some of the content data stored in the display device 100 can be transmitted to another user or another electronic device selected from among users or other electronic devices pre-registered in the display device 100.

The storage unit 140 can store programs for each signal processing and control within the controller 170 and store signal-processed images, voices, or data signals.

In addition, the storage unit 140 can perform a function for temporary storage of video, audio, or data signals input from the external device interface unit 135 or the network interface unit 133, and can store information about a given image through a channel memory function.

The storage unit 140 can store an application or an application list input from the external device interface unit 135 or the network interface unit 133.

The display device 100 can reproduce content files (video files, still image files, music files, document files, application files, etc.) stored in the storage unit 140 and provide them to the user.

The user input interface unit 150 can transmit a signal input by the user to the controller 170, or transmit a signal from the controller 170 to the user. For example, the user input interface unit 150 can receive and process control signals such as power on/off, channel selection, and screen settings from the remote control device 200 according to various communication methods such as Bluetooth, Ultra Wideband (UWB), ZigBee, Radio Frequency (RF) communication, or IR communication, or can process control signals from the controller 170 to be transmitted to the remote control device 200.

In addition, the user input interface unit 150 can transmit control signals input from local keys (not shown) such as power keys, channel keys, volume keys, and settings to the controller 170.

The image signal processed by the controller 170 can be input to the display 180 and displayed as an image corresponding to the image signal. In addition, the image signal processed by the controller 170 can be input to an external output device through the external device interface unit 135.

The voice signal processed in the controller 170 can be output as audio to the audio output unit 185. In addition, the voice signal processed in the controller 170 can be input to an external output device through the external device interface unit 135.

In addition, the controller 170 can control the overall operation within the display device 100.

In addition, the controller 170 can control the display device 100 by a user command or an internal program input through the user input interface unit 150, and can connect to a network to allow the user to download a desired application or application list into the display device 100.

The controller 170 can allow the user-selected channel information, etc. to be output together with the processed image or audio signal through the display 180 or the audio output unit 185.

In addition, the controller 170 allows an image signal or an audio signal from an external device, for example, a camera or a camcorder, input through the external device interface unit 135 to be output through the display 180 or the audio output unit 185 according to an external device image playback command received through the user input interface unit 150.

Meanwhile, the controller 170 can control the display 180 to display an image, and for example, can control a broadcast image input through the tuner 131, an external input image input through the external device interface unit 135, an image input through the network interface unit, or an image stored in the storage unit 140 to be displayed on the display 180. In this case, the image displayed on the display 180 can be a still image or a moving image, and can be a 2D image or a 3D image.

In addition, the controller 170 can control the content stored in the display device 100, or the received broadcast content, or the external input content input from the outside to be played, and the content can be in various forms such as broadcast images, external input images, audio files, still images, connected web screens, and document files.

The wireless communication unit 173 can perform communication with an external device through wired or wireless communication. The wireless communication unit 173 can perform short range communication with an external device. To this end, the wireless communication unit 173 can support short range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (Wireless USB) technologies. The wireless communication unit 173 can support wireless communication between the display device 100 and a wireless communication system, between the display device 100 and another display device 100, or between the display device 100 and a network where the display device (100, or an external server) is located through a short-range wireless communication network (Wireless Area Networks). The short-range wireless communication network can be a short-range wireless personal area network (Wireless Personal Area Networks).

Here, the other display device 100 can be a wearable device (e.g., a smartwatch, smart glass, a head mounted display (HMD), a mobile terminal such as a smart phone) that can exchange data with the display device 100 according to the present invention (or can be linked). The wireless communication unit 173 can detect (or recognize) a wearable device capable of communication around the display device 100. Furthermore, if the detected wearable device is an authenticated device to communicate with the display device 100 according to the present invention, the controller 170 can transmit at least a part of the data processed in the display device 100 to the wearable device through the wireless communication unit 173. Accordingly, the user of the wearable device can use the data processed in the display device 100 through the wearable device.

The voice acquisition unit 175 Audio can be acquired. The voice acquisition unit 175 can include at least one microphone (not shown) and can acquire audio around the display device 100 through the microphone (not shown).

The display 180 can convert the image signal, data signal, OSD signal processed by the controller 170 or the image signal, data signal, etc. received from the external device interface unit 135 into R, G, B signals, respectively, to generate a driving signal.

Meanwhile, the display device 100 illustrated in FIG. 1 is only an embodiment of the present invention. Some of the illustrated components can be integrated, added, or omitted according to the specifications of the display device 100 actually implemented.

That is, two or more components can be combined into one component, or one component can be subdivided into two or more components, as needed. In addition, the functions performed by each block are for explaining the embodiments of the present invention, and the specific operations or devices thereof do not limit the scope of the rights of the present invention.

According to another embodiment of the present invention, the display device 100 can receive and play back images through the network interface unit 133 or the external device interface unit 135 without having a tuner 131 and a demodulator 132 as shown in FIG. 1.

For example, the display device 100 can be implemented separately as an image processing device, such as a set-top box, for receiving contents according to broadcast signals or various network services, and a content playback device for playing back contents input from the image processing device.

In this case, the operation method of the display device according to the embodiment of the present invention described below can be performed by any one of the image processing devices, such as a separate set-top box, or a content playback device having a display 180 and an audio output unit 185, as well as the display device 100 described with reference to FIG. 1.

The audio output unit 185 receives a signal processed by the controller 170 and outputs it as voice.

The power supply unit 190 supplies the corresponding power to the entire display device 100. In particular, power can be supplied to the controller 170 that can be implemented in the form of a system on chip (SOC), the display 180 for displaying images, and the audio output unit 185 for audio output.

Specifically, the power supply unit 190 can be equipped with a converter that converts AC power into DC power and a dc/dc converter that converts the level of the DC power.

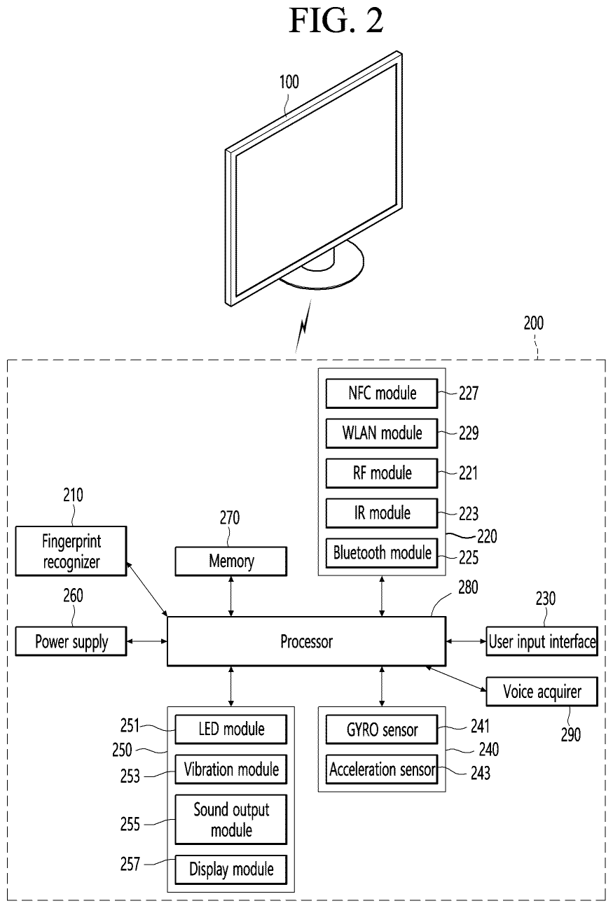

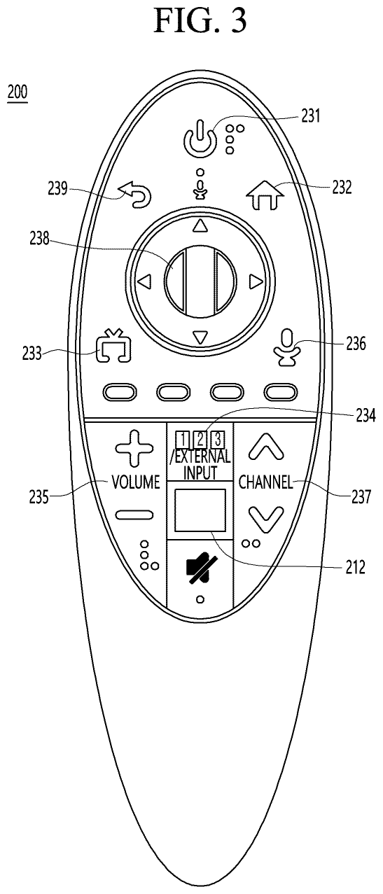

Next, with reference to FIGS. 2 and 3, a remote control device according to an embodiment of the present invention will be described.

FIG. 2 is a block diagram of a remote control device according to an embodiment of the present invention, and FIG. 3 illustrates an example of an actual configuration of a remote control device according to an embodiment of the present invention.

First, with reference to FIG. 2, a remote control device 200 can include a fingerprint recognition unit 210, a wireless communication unit 220, a user input unit 230, a sensor unit 240, an output unit 250, a power supply unit 260, a storage unit 270, a controller 280, and a voice acquisition unit 290.

With reference to FIG. 2, the wireless communication unit 220 transmits and receives signals with any one of the display devices according to the embodiments of the present invention described above.

The remote control device 200 can be equipped with an RF module 221 capable of transmitting and receiving signals with the display device 100 according to RF communication standards, and an IR module 223 capable of transmitting and receiving signals with the display device 100 according to IR communication standards. In addition, the remote control device 200 can be equipped with a Bluetooth module 225 capable of transmitting and receiving signals with the display device 100 according to Bluetooth communication standards. In addition, the remote control device 200 can be equipped with an NFC module 227 capable of transmitting and receiving signals with the display device 100 according to NFC communication standards, and a WLAN module 229 capable of transmitting and receiving signals with the display device 100 according to Wireless LAN (WLAN) communication standards.

In addition, the remote control device 200 transmits a signal containing information about the movement of the remote control device 200 to the display device 100 through the wireless communication unit 220.

Meanwhile, the remote control device 200 can receive a signal transmitted by the display device 100 through the RF module 221, and, if necessary, can transmit commands for power on/off, channel change, volume change, etc. to the display device 100 through the IR module 223.

The user input unit 230 can be composed of a keypad, a button, a touch pad, or a touch screen. The user can input a command related to the display device 100 to the remote control device 200 by operating the user input unit 230. If the user input unit 230 is equipped with a hard key button, the user can input a command related to the display device 100 to the remote control device 200 through a push operation of the hard key button. This will be described with reference to FIG. 3.

Referring to FIG. 3, the remote control device 200 can include a plurality of buttons. The plurality of buttons can include a fingerprint recognition button 212, a power button 231, a home button 232, a live button 233, an external input button 234, a volume control button 235, a voice recognition button 236, a channel change button 237, a confirmation button 238, and a back button 239.

The fingerprint recognition button 212 can be a button for recognizing a user's fingerprint. In one embodiment, the fingerprint recognition button 212 can be capable of a push operation, and can receive a push operation and a fingerprint recognition operation. The power button 231 can be a button for turning the power of the display device 100 on/off. The home button 232 can be a button for moving to the home screen of the display device 100. The live button 233 can be a button for displaying a real-time broadcast program. The external input button 234 can be a button for receiving an external input connected to the display device 100. The volume control button 235 can be a button for adjusting the volume output by the display device 100. The voice recognition button 236 can be a button for receiving a user's voice and recognizing the received voice. The channel change button 237 can be a button for receiving a broadcast signal of a specific broadcast channel. The confirmation button 238 can be a button for selecting a specific function, and the back button 239 can be a button for returning to the previous screen.

FIG. 2 will be described again.

If the user input unit 230 has a touch screen, the user can input a command related to the display device 100 using the remote control device 200 by touching the soft key of the touch screen. In addition, the user input unit 230 can be equipped with various types of input means that can be operated by the user, such as a scroll key or a jog key, and this embodiment does not limit the scope of the rights of the present invention.

The sensor unit 240 can be equipped with a gyro sensor 241 or an acceleration sensor 243, and the gyro sensor 241 can sense information about the movement of the remote control device 200.

For example, the gyro sensor 241 can sense information about the operation of the remote control device 200 based on the x, y, and z axes, and the acceleration sensor 243 can sense information about the movement speed of the remote control device 200. Meanwhile, the remote control device 200 can further be equipped with a distance measuring sensor, and can sense the distance to the display 180 of the display device 100.

The output unit 250 can output a video or audio signal corresponding to the operation of the user input unit 230 or the signal transmitted from the display device 100. Through the output unit 250, the user can recognize whether the user input unit 230 is being operated or whether the display device 100 is being controlled.

For example, the output unit 250 can be equipped with an LED module 251 that lights up when the user input unit 230 is operated or a signal is transmitted and received with the display device 100 through the wireless communication unit 220, a vibration module 253 that generates vibration, an audio output module 255 that outputs sound, or a display module 257 that outputs an image.

In addition, the power supply unit 260 supplies power to the remote control device 200, and reduces power waste by stopping the power supply when the remote control device 200 does not move for a predetermined period of time. The power supply unit 260 can resume power supply when a predetermined key equipped in the remote control device 200 is operated.

The storage unit 270 can store various types of programs, application data, etc. required for the control or operation of the remote control device 200. If the remote control device 200 wirelessly transmits and receives signals through the display device 100 and the RF module 221, the remote control device 200 and the display device 100 transmit and receive signals through a predetermined frequency band.

The controller 280 of the remote control device 200 can store and refer to information about the frequency band, etc., that can wirelessly transmit and receive signals with the display device 100 paired with the remote control device 200 in the storage unit 270.

The controller 280 controls all matters related to the control of the remote control device 200. The controller 280 can transmit a signal corresponding to a predetermined key operation of the user input unit 230 or a signal corresponding to a movement of the remote control device 200 sensed by the sensor unit 240 to the display device 100 through the wireless communication unit 220.

In addition, the voice acquisition unit 290 of the remote control device 200 can acquire voice.

The voice acquisition unit 290 can include at least one microphone 291 and can acquire voice through the microphone 291.

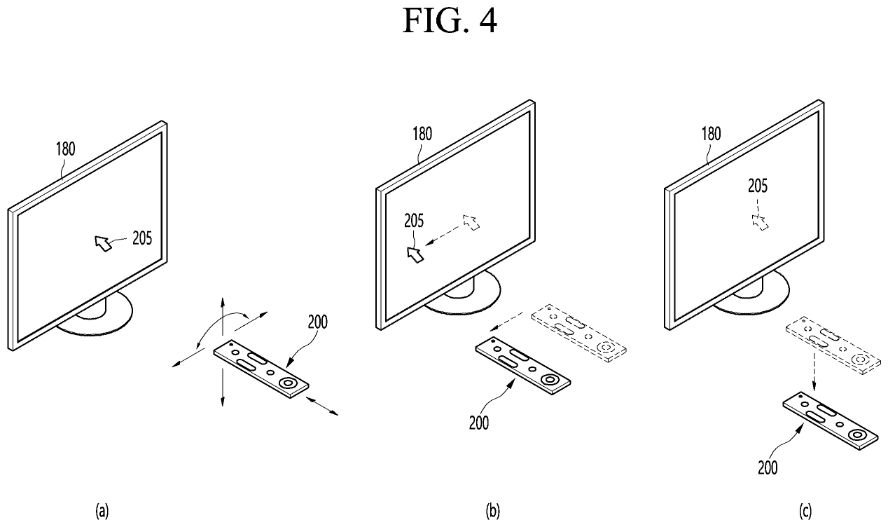

Next, FIG. 4 is described.

FIG. 4 illustrates an example of utilizing a remote control device according to an embodiment of the present invention.

FIG. 4 (a) illustrates that a pointer 205 corresponding to a remote control device 200 is displayed on a display 180.

A user can move or rotate the remote control device 200 up and down, left and right. The pointer 205 displayed on the display 180 of the display device 100 corresponds to the movement of the remote control device 200. This remote control device 200 can be named a space remote control because, as shown in the drawing, the pointer 205 moves and is displayed according to the movement in 3D space.

(b) of FIG. 4 exemplifies that when a user moves the remote control device 200 to the left, the pointer 205 displayed on the display 180 of the display device 100 also moves to the left in response.

Information about the movement of the remote control device 200 detected by the sensor of the remote control device 200 is transmitted to the display device 100. The display device 100 can calculate the coordinates of the pointer 205 from the information about the movement of the remote control device 200. The display device 100 can display the pointer 205 in response to the calculated coordinates.

(c) of FIG. 4 exemplifies a case where a user moves the remote control device 200 away from the display 180 while pressing a specific button in the remote control device 200. By this, the selection area in the display 180 corresponding to the pointer 205 can be zoomed in and displayed in an enlarged manner.

Conversely, when the user moves the remote control device 200 closer to the display 180, the selection area in the display 180 corresponding to the pointer 205 can be zoomed out and displayed in a reduced manner.

Meanwhile, when the remote control device 200 moves away from the display 180, the selection area can be zoomed out, and when the remote control device 200 moves closer to the display 180, the selection area can be zoomed in.

In addition, when a specific button in the remote control device 200 is pressed, the recognition of up, down, left, and right movements can be excluded. That is, when the remote control device 200 moves away from or closer to the display 180, the up, down, left, and right movements can be recognized only, and only the forward and backward movements can be recognized. When a specific button in the remote control device 200 is not pressed, only the pointer 205 moves according to the up, down, left, and right movements of the remote control device 200.

Meanwhile, the moving speed or moving direction of the pointer 205 can correspond to the moving speed or moving direction of the remote control device 200.

Meanwhile, the pointer in this specification refers to an object displayed on the display 180 in response to the operation of the remote control device 200. Therefore, objects of various shapes other than the arrow shape illustrated in the drawing are possible as the pointer 205. For example, it can be a concept including a point, a cursor, a prompt, a thick outline, etc. In addition, the pointer 205 can be displayed corresponding to one point of the horizontal and vertical axes on the display 180, and can also be displayed corresponding to multiple points such as a line or a surface.

Hereinafter, a display device 100 that automatically controls a core voltage (Vcore, core voltage) by monitoring a temperature according to the present invention and an operation method thereof will be described.

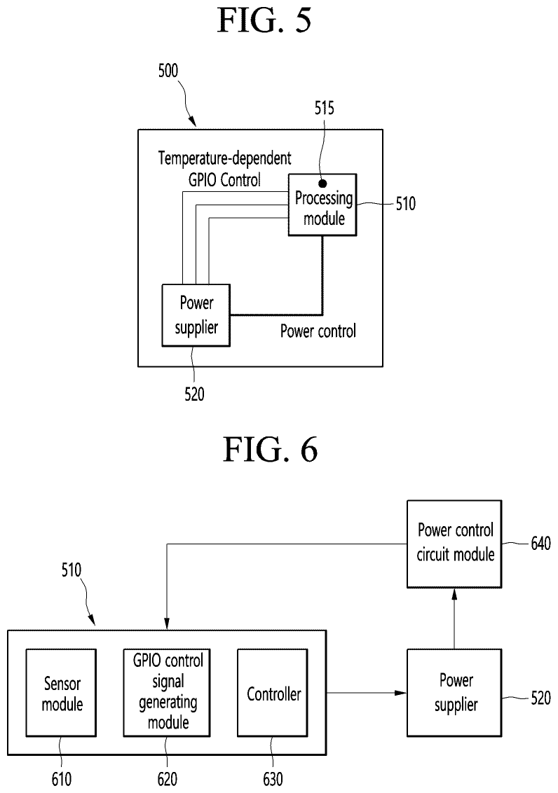

FIG. 5 is a drawing illustrating a core power automatic control device 500 according to an embodiment of the present invention.

FIG. 6 is a block diagram of the core power automatic control device 500 of FIG. 5.

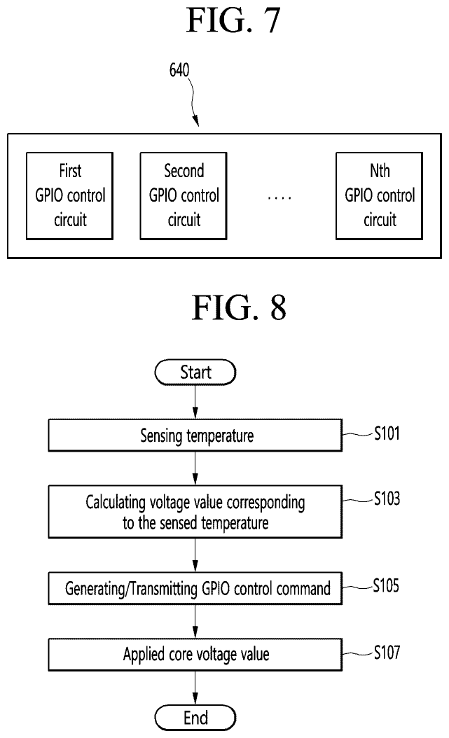

FIG. 7 is a block diagram of the power control circuit module 640 of FIG. 6.

The display device 100 can include a core voltage automatic control device 500 according to an embodiment of the present invention.

Referring to FIG. 5, the core power automatic control device 500 can include a processor 510 and a power supply unit 520.

The processor 510 is a hardware configuration that processes various signals of the display device 100, and can correspond to or be a part of, for example, a main board, a SoC, a controller 170 of FIG. 1, etc.

According to one embodiment, the processor 510 can include a temperature sensor. Here, the inclusion of the temperature sensor can also refer to, for example, a case in which the temperature sensor is installed and built into a semiconductor die for the processor 510 or a case in which the temperature sensor is provided on a board within the display device 100.

In particular, when the temperature sensor is built into the processor 510, the temperature sensor can be used to sense or monitor the die junction temperature. The temperature sensor built into the processor 510 in this way is distinguished from the external case temperature measurement value of the display device 100 and can be compared. In relation to this, in the present invention, the temperature of the processor 510 sensed through the built-in temperature sensor can be used, which is distinguished from the external case temperature measurement value.

The power supply unit 520 can supply power to the processor 510.

Meanwhile, according to the present invention, the processor 510 can automatically control the power supplied through the power supply unit 520 based on the temperature value monitored through the built-in temperature sensor.

Referring to FIG. 6, the detailed configuration of the core power automatic control device 500 is as follows.

The processor 510 can be configured to include a sensor unit 610, a General Purpose Input Output (GPIO) control signal generation unit 620, a controller 630, etc.

The sensor unit 610 can correspond to or include a temperature sensor built into the processor 510 of the aforementioned FIG. 5.

The sensor unit 610 can sense the temperature of the processor 510 under the control of the controller 630 and transmit the sensed temperature value to the GPIO control signal generation unit 620 and/or the controller 630.

The GPIO control signal generation unit 620 can receive the temperature value transmitted through the sensor unit 610 or the control command of the controller 630, generate a GPIO control signal (or control command) corresponding to the temperature value, and transmit it to the power supply unit 520. At this time, the transmission can be performed under the control of the controller 630 or through the controller 630.

The controller 630 can control the overall operation of the processor 510.

For example, the controller 630 can generate at least one look-up table (LUT) and store it in the memory 140 to automatically control the power (core voltage) supplied from the power supply unit 520 through the GPIO control signal based on the sensed temperature value.

Meanwhile, in relation to the present invention, a power control circuit module 640 can be further included in the core power automatic control device 500 to support the temperature-based power supply unit 520 control of the processor 510 in hardware.

According to an embodiment, the power control circuit module 640 can be implemented as an independent component separate from the processor 510 and the power supply unit 520. Hereinafter, for convenience, the power control circuit module 640 is described as an independent component, but is not limited thereto.

For example, according to another embodiment, the power control circuit module 640 can be implemented as a component of either the processor 510 or the power supply unit 520.

Referring to FIG. 7, the power control circuit module 640 can be implemented by including n (where n is a natural number) GPIO control circuits.

For example, the circuit configuration of the power control circuit module 640 illustrated in FIG. 7 can be determined based on, for example, a setting range of a temperature value, a setting range of a core voltage value, etc.

Depending on the embodiment, the circuit configuration of the power control circuit module 640 can be determined according to the configuration or definition of a lookup table (LUT).

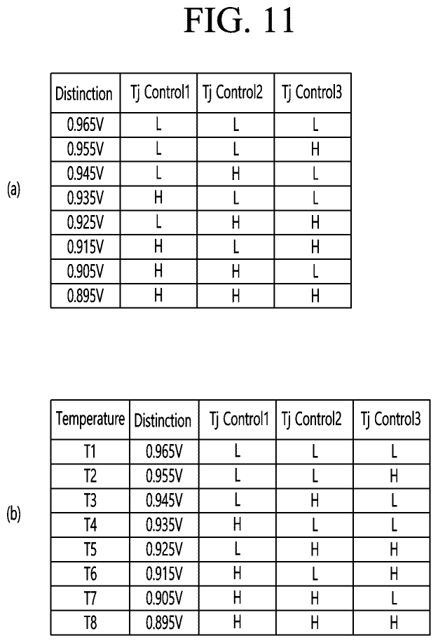

For example, the Tⱼ control values shown in (a) or (b) of FIG. 11 are defined by three each, and accordingly, the power control circuit module 640 can include three GPIO control circuits. Accordingly, the lookup table (LUT) can automatically control a total of eight core voltage values by distinguishing them. However, the present invention is not limited thereto.

For example, by adjusting the number of the GPIO control circuits, the setting of the core voltage value can be arbitrarily adjusted and controlled.

(a) of FIG. 11 is a lookup table (LUT) that defines a total of eight stages between the maximum core voltage value of 0.965 V and the minimum core voltage value of 0.895 V, and each core voltage value can be viewed as a voltage value (Vcore) that is finally applied to the processor 510, i.e., the core, through the voltage supply unit 520.

Meanwhile, in a similar manner, in (b) of FIG. 11, a temperature factor is further included, so that the temperature, core voltage value, and GPIO control command are mapped to each other.

For example, referring to (b) of FIG. 11, if the temperature sensing result temperature value corresponds to T4, the processor 510 can set the first GPIO control circuit to High, the second GPIO control circuit to Low, and the third GPIO control circuit to Low so that the core voltage value applied to the final processor 510 through the voltage supply unit 520 becomes 0.935 V.

The processor 510 can set the range of the core voltage value through a pre-test.

According to an embodiment, the processor 510 can set the maximum or minimum core voltage value to an arbitrary value instead of mapping the core voltage value by setting a specific value from the beginning as in FIG. 11, and can also set only the difference (voltage difference value) from the arbitrary value set in response to each temperature item. To this end, the circuit configuration of FIG. 7 can be different from the circuit configuration described above (e.g., including a variable resistor, etc.).

According to another embodiment, the processor 510 can generate and store multiple lookup tables (LUTs) such as (a) or (b) of FIG. 11 in which various temperature-voltage values are mapped according to preset criteria, and can select one of them to use for power control. At this time, the processor 510 can select and use another lookup table (LUT) instead of the initially selected lookup table (LUT) in the power control process depending on various circumstances such as events.

The operating method of the display device according to the present invention will be described in more detail with reference to FIGS. 8 to 14.

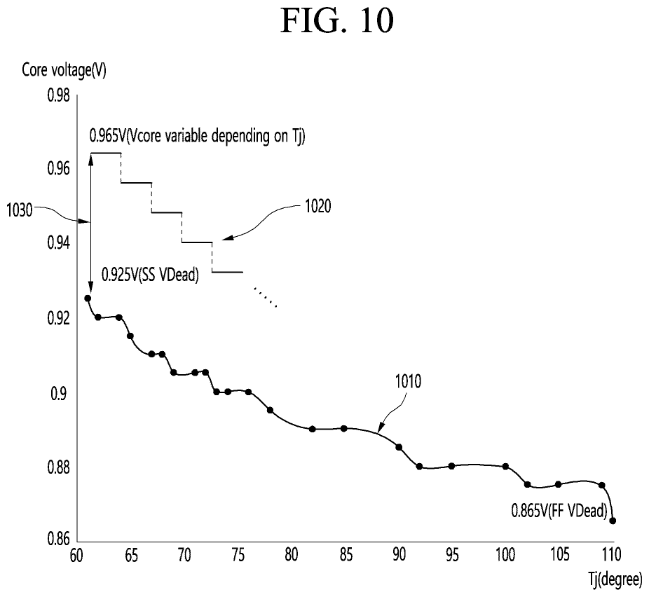

FIGS. 8 to 9 and FIGS. 12 to 14 are flowcharts illustrating a power control method in a display device 100 according to an embodiment of the present invention. FIG. 10 is a graph illustrating the power control method of FIG. 8. FIG. 11 illustrates a lookup table (LUT) for power control according to an embodiment of the present invention.

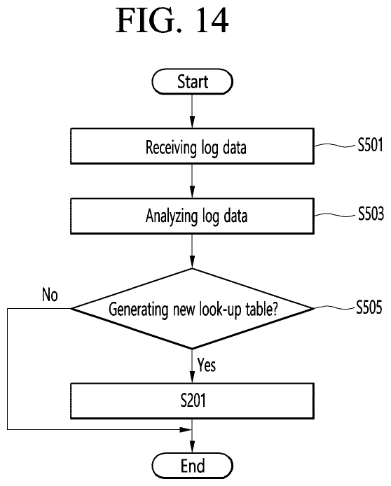

For convenience of explanation, FIGS. 8, 9, 12, and 13 are all described from the perspective of the processor 510 (or the controller 630), but are not limited thereto. Meanwhile, FIG. 14 can be performed by the processor 510 or a server (not shown).

The operating method of the display device 100 according to one embodiment of the present invention generates and stores a lookup table in which the temperature of the processor (e.g., SoC) 510, the core voltage value to be applied to the processor 510, and the GPIO control command for applying the core voltage value are mapped, reads the temperature of the processor 510 through a temperature sensor installed in the semiconductor die of the processor 510, calculates a core voltage value corresponding to the current temperature of the read processor 510, generates a GPIO control command corresponding to the calculated core voltage value, and transmits it to a power supply unit (e.g., power IC) 520, and controls the power supply according to the transmitted GPIO control command.

Referring to FIG. 8, the processor 510 can read the temperature value through the temperature sensor (S101).

The processor 510 can calculate a voltage value corresponding to the temperature value read in the step S101, i.e., a core voltage value (S103).

The processor 510 can extract a corresponding GPIO control value from a lookup table (LUT) to receive the corresponding core voltage value through the power supply unit 520 based on the core voltage value calculated in the step S103, and can generate a GPIO control command based on the extracted GPIO control value and transmit it to the power supply unit 520 (S105).

The processor 510 can receive a core voltage value according to the GPIO control command through the power supply unit 520 based on the read temperature value (S107).

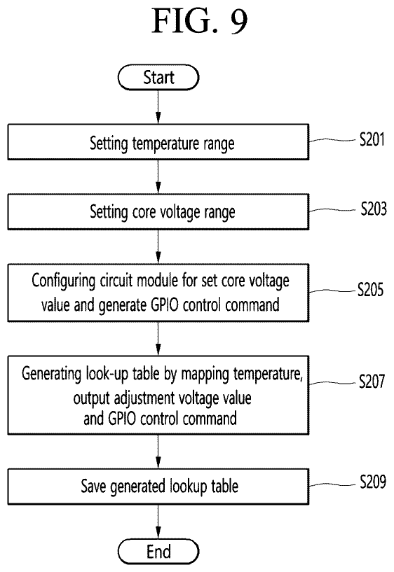

FIG. 9 can be an example of the process of generating and storing a lookup table (LUT) used in FIG. 8, for example. According to an embodiment, FIG. 9 can be performed before step S101 of FIG. 8, i.e., temperature sensing.

Referring to FIG. 9, the processor 510 can first set a range for a temperature value that is the basis of automatic power control according to the present invention (S201).

The processor 510 can then set a range for the adjustment voltage compared to the output voltage of the power supply unit 520 according to the set temperature, i.e., the core voltage value that is finally applied to the processor 510 (S203).

The processor 510 can configure a circuit module so that a core voltage value within the set range can be applied through the S203 step, and can generate a GPIO control command that allows each core voltage value to be applied through the configured circuit module (S205).

The processor 510 can generate a lookup table (LUT) by mapping the temperature range and core voltage value range set through the above steps S201 to S203 and the GPIO control command generated through the above step S205 (S207).

The processor 510 can store the lookup table (LUT) generated through the step S207 (S209).

Meanwhile, the above-described FIG. 9 is a flow chart for generating one lookup table (LUT), and each of the above-described lookup tables (LUT) can be generated and stored through the above-described process.

FIG. 10 is a graph illustrated to explain control of the core voltage value according to temperature according to one embodiment of the present invention.

Referring to FIG. 10, the vertical axis of the graph can represent the core voltage value (V) and the horizontal axis can represent the temperature (Tⱼ).

Points 1010 in the graph of FIG. 10 can represent core voltage values that can operate normally at the corresponding temperature.

As described above, the points 1010 can obtain information about the corresponding values through preliminary tests.

Meanwhile, the core voltage value 1020 that is finally applied to the processor 510 through the power supply unit 520 according to the present invention cannot be a value that matches the points 1010. Referring to the graph of FIG. 10, a margin 1030 can be designed between each point 1010 and the core voltage value 1020 that is applied to the processor 510. In FIG. 10, when the temperature (Tⱼ) is 60, the core voltage value 1010 that can operate normally indicated by the point 1010 is 0.925 V, whereas the core voltage value 1020 applied to the actual processor 510 via the power supply unit 520 is 0.965 V, which is designed to have a voltage margin 1030 of 0.4 V. However, this is only one embodiment according to the present invention, and is not limited thereto.

According to the embodiment, FIG. 10 is designed to have the same margin 1030 for all points, but is not limited thereto.

That is, the margin according to the present invention can be set differently depending on the point or temperature. For example, the margin (margin A) set when the temperature (Tⱼ) is 80 degrees or less and the margin (margin B) set when the temperature (Tⱼ) exceeds 80 degrees can be designed differently. In the above case, the margin A can be smaller than the margin B. This is because, when the temperature (Tⱼ) is relatively low, even if the margin is set small and then periodically responds to the temperature change, the impact on the device can be small.

On the other hand, when the temperature (Tⱼ) is high, it is relatively more sensitive to the set margin and can have a large impact on the device, so it can be desirable to design a margin with some margin.

Meanwhile, the present invention can also control the temperature measurement cycle differently by determining it according to the margin design, that is, the set margin. According to an embodiment, when the margin is set small, the impact on the device can be relatively large compared to when the margin is set large, so it can be changed to a shorter cycle compared to the normally set temperature measurement cycle.

According to another embodiment, if the margin is set to a large value, there is a concern that power consumption can increase due to excessive margin setting, so the temperature measurement cycle can be changed to a shorter cycle than the normally set temperature measurement cycle.

According to another embodiment, the margin can be designed to be set differently from other temperatures only at least at one or more specific temperatures.

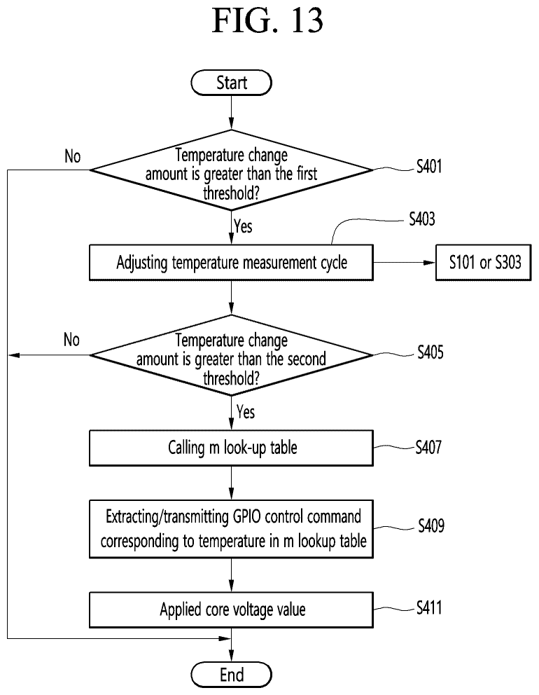

According to another embodiment, this margin design can be designed so that the margin to be applied is different from before when the temperature change amount exceeds the threshold as a result of the temperature check at a predefined cycle similar to FIG. 13 described below.

According to an embodiment, the points 1010 can be values pre-set by the manufacturer of the display device 100, for example. For the setting, the manufacturer can collect various data on related parts or semiconductor devices, and determine and set based on the collected data. Alternatively, the manufacturer can set using the average value of the data.

According to an embodiment, when the manufacturer sets the core voltage value 1010 according to the target temperature, i.e., the points 1010 based on the collected data or using the average value, the margin 1030 between the core voltage value 1020 to be finally applied to the processor 510 through the voltage supply unit 520 according to the present invention can be set differently from other cases. For example, the margin (first margin) for the core voltage value 1010 to be set for the points 1010 confirmed through a pre-test for the display device 100 and the margin (second margin) for the core voltage value 1010 in the case of arbitrarily setting based on the collected data can be different from each other. According to an embodiment, the second margin can be relatively larger than the first margin.

Meanwhile, referring to FIG. 10, the core voltage value 1020 can correspond to multiple points, not necessarily to only one point 1010 as described above. In other words, in FIG. 10, the core voltage value 1020 can correspond one-to-one to each core voltage value 1010 that can operate depending on the temperature (Tⱼ), but one core voltage value 1020 can be assigned and set for core voltage values around a specific core voltage value 1010 (i.e., the difference is less than a threshold value).

Therefore, referring to FIG. 10, for example, when the temperature measurement cycle is constant, the voltage applied to the processor 510 can change stepwise depending on the temperature change.

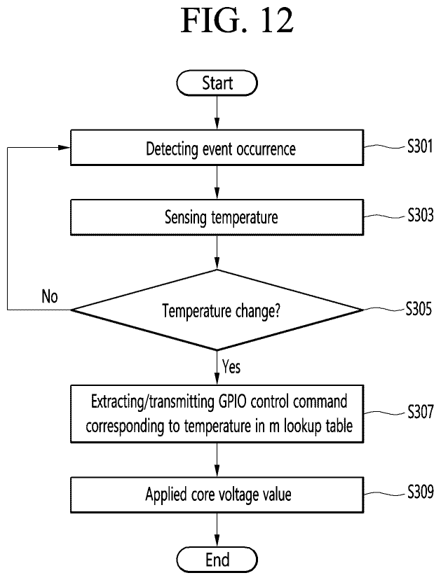

Meanwhile, referring to FIG. 12, the display device 100 can automatically control the core power appropriately according to the event that occurs.

Referring to FIG. 12, the processor 510 can detect the occurrence of an event (S301). Such an event can be preset in relation to the present invention. Here, the event can include various situations occurring in the display device 100, and for example, can include the occurrence of various situations such as a confirmation request for power-on, temperature measurement, input change, device error, or occurrence of a warning or receipt of separate upgrade data.

When the occurrence of the event is detected, the processor 510 can sense, i.e., read, the current temperature using a temperature sensor (S303).

The processor 510 can determine whether there is a temperature change based on the current temperature read in step S303 (S305). Here, the determination of the temperature change is to determine whether a different core voltage value is set from before according to the changed temperature, since the core voltage value 1020 set according to the temperature is different, as shown in the graph of FIG. 10.

According to an embodiment, the processor 510 can determine the temperature change by whether the core voltage value 1020 is set to change. That is, even if there is a temperature change, if the core voltage value 1020 does not need to be set to change, the temperature change is determined not to be a temperature change and can be disregarded.

Meanwhile, referring to FIG. 10, since the core voltage value 1020 set according to the temperature can be changed, the difference in temperature value from the temperature read during the previous measurement, that is, the magnitude of the temperature change, cannot be very important.

If the processor 510 determines that there is a temperature change in the above step S305, it can extract the corresponding temperature-corresponding GPIO control command in the nth lookup table (LUT) and transmit it to the power supply unit 520.

In the above, n is a natural number, and in this case, if there are multiple lookup tables (LUTs), a specific lookup table (LUT) can be selected and used. Depending on the embodiment, the specific lookup table (LUT) to be selected can be determined, for example, according to the type of the event. For example, in a case other than the situation as in FIG. 13, a default lookup table (default LUT) can be selected and applied.

The processor 510 can receive a core voltage value corresponding to the transmitted GPIO control command through the power supply unit 520 through the above step S307 (S309).

Next, in the case of FIG. 13, it can be seen as an example of automatically controlling power based on the temperature change amount. Here, the temperature change amount can be, for example, identical to or completely different from the temperature change defined in FIG. 12 described above. For example, in the latter case, it can simply mean the absolute temperature change difference value from the previous measured temperature.

Meanwhile, in FIG. 13, the display device 100 can automatically control power appropriately based on, for example, a plurality of lookup tables (LUTs) equipped or pre-stored.

The processor 510 can determine whether the temperature change amount is greater than or equal to the first threshold value (S401).

In this case, before determining the temperature change amount, temperature measurement, etc. can refer to the process before the temperature measurement described above.

If the processor 510 determines in step S401 that the temperature change amount of the current measurement temperature compared to the previous measurement temperature is greater than or equal to the first threshold, the processor 510 can adjust the preset temperature measurement cycle (S403). At this time, the temperature measurement cycle can coincide with or include the temperature change detection cycle.

If the processor 510 adjusts the temperature measurement cycle in step S403, the processor 510 can perform steps S101 and below of FIG. 8 or steps S303 and below of FIG. 12.

Meanwhile, if the temperature change amount determined in step S401 is greater than or equal to the first threshold, the processor 510 can further determine whether the temperature change amount is greater than or equal to the second threshold (S405).

The processor 510 can call the m lookup table (LUT) from the memory 140 (S407) if the temperature change amount is greater than or equal to the second threshold value as a result of the judgment in the step S405, and extract the GPIO control command corresponding to the temperature in the called m lookup table (LUT) and transmit it to the power supply unit 520 (S409).

At this time, the m can also be a natural number and, for example, a value different from n in the aforementioned FIG. 12. The S409 is intended to, for example, apply a new lookup table (LUT) instead of the existing lookup table (LUT) in order to resolve the problem or issue by considering that a problem or issue has occurred in the device if the temperature change amount is large.

According to an embodiment, the m lookup table (LUT) called can be, for example, a lookup table (LUT) predefined according to the threshold or temperature change amount. For example, if the temperature change amount is less than the second threshold, the second lookup table (LUT) can be called and used, and if it is greater than the second threshold, the third lookup table (LUT) can be called and used, but is not limited thereto.

The processor 510 can receive a core voltage value corresponding to the GPIO control command transmitted in step S409 (S411).

Referring to FIG. 14, the display device 100 can update the lookup table (LUT) or generate a new lookup table (LUT) and store it and then use it.

The above process can be performed by, for example, the display device 100, but for convenience of explanation, the present invention will be described as an example of using the log data of the display device 100 in a server (not shown). The server can be, for example, a server operated or provided by the manufacturer of the display device 100.

Referring to FIG. 14, the server can receive (or obtain) the log data of the display device 100 (S501).

In the above, the log data can be data related to the automatic power control according to the present invention, such as a temperature measurement value, a temperature change amount, a temperature measurement cycle, and a lookup table (LUT) selection/application information.

The server can analyze the received log data (S503).

At this time, the server can refer to the log data of another display device and the analysis contents thereof when analyzing the log data. The above other display can be arbitrarily selected based on, but is not limited to, network information, regional or geographical information, user information such as age, gender, and inclination, product information, etc.

The server can determine whether to create a new lookup table based on the log data analysis result in step S503 (S505). At this time, the determination can indicate, for example, whether to create a new lookup table in the target display device 100.

If the server determines that a new lookup table (LUT) needs to be created for the corresponding display device as a result of the determination in step S505, the server can transmit related data to the target display device.

The processor 510 can calculate temperature change data after power supply according to the voltage value on the lookup table corresponding to the temperature sensed by the temperature sensor. At this time, the temperature change data can include temperature increase/decrease data and temperature increase/decrease time data. The above processor 510 can, on the other hand, learn the temperature change data and reflect the learning result to upgrade or update the lookup table.

The above description is merely an example of the technical idea of the present invention, and those with ordinary knowledge in the technical field to which the present invention belongs can make various modifications and variations without departing from the essential characteristics of the present invention.

Therefore, the embodiments disclosed in the present invention are not intended to limit the technical idea of the present invention but to explain it, and the scope of the technical idea of the present invention is not limited by these embodiments.

The protection scope of the present invention should be interpreted by the claims below, and all technical ideas within the equivalent scope should be interpreted as being included in the scope of the rights of the present invention.

### Industrial Applicability

According to the display device according to the present disclosure, a core voltage applied based on temperature can be automatically controlled despite the characteristics of the semiconductor element, so that an optimal solution can be designed as a heat dissipation measure, and therefore, the industrial applicability is remarkable.

What is claimed is:

1. A display device comprising:
a memory;
a processor including a temperature sensor; and
a power supply unit for supplying power to the processor,
wherein the processor is configured to transmit a GPIO control command to the power supply unit according to a temperature value sensed by the temperature sensor, and control a core voltage value corresponding to the GPIO control command to be applied through the power supply unit.

2. The display device according to claim 1, wherein the memory stores a lookup table in which a temperature, a core voltage value, and a GPIO control command of the processor are mapped.

3. The display device according to claim 2, further comprising a power control circuit module configured to control an output voltage value of the power supply unit to be adjusted to the core voltage value corresponding to the GPIO control command.

4. The display device according to claim 2, wherein the power supply unit includes a power control circuit module configured to control an output voltage value to be adjusted to the core voltage value corresponding to the GPIO control command.

5. The display device according to claim 3, wherein the power control circuit module is implemented with a plurality of control circuits so that the output voltage value of the power supply unit is applied to the processor as the core voltage value defined in the lookup table.

6. The display device according to claim 3, wherein the processor is configured to detect a normal operating voltage value at each temperature defined on the lookup table.

7. The display device according to claim 6, wherein the processor is configured to determine a range of a core voltage value to which a first margin is applied to the detected normal operating voltage value.

8. The display device according to claim 7, wherein the processor is further configured to detect the occurrence of an event, and generate a GPIO control command corresponding to the maximum core voltage value according to the type of the detected event and transmit it to the power supply unit.

9. The display device according to claim 7, wherein the processor is configured to determine whether the change in temperature measured by the temperature sensor is greater than or equal to a first threshold.

10. The display device according to claim 9, wherein the processor is configured to adjust a preset temperature measurement cycle to be changed when the change in temperature is greater than or equal to the first threshold.

11. The display device according to claim 9, wherein the processor is configured to determine whether the change in temperature measured by the temperature sensor is greater than or equal to a second threshold.

12. The display device according to claim 11, wherein the processor is configured to call and apply another lookup table from the memory instead of the previously used lookup table when the change in the temperature is greater than or equal to the second threshold.

13. The display device according to claim 12, wherein the called another lookup table is mapped core voltage values to which a second margin applied, which is different from the previously used lookup table in terms of margin design value.

14. The display device according to claim 7, wherein the processor is configured to transmit log data related to the lookup table to a server, and receive update data of the lookup table according to the analysis of the log data from the server.

15. A method of operating a display device comprising:
generating and storing a lookup table in which a temperature of a System on Chip (SoC), a core voltage value to be applied to the SoC, and a GPIO control command for applying the core voltage value are mapped;
reading a temperature of the SoC through a temperature sensor installed in a SoC die;
calculating a core voltage value corresponding to the read current temperature of the SoC;
generating a GPIO control command corresponding to the calculated core voltage value and transmitting it to a power IC; and
controlling a supply power according to the transmitted GPIO control command.
